(19) United States
(12) Patent Application Publication
(10) Pub. No.: US 2004/0098379 A1
(43) Pub. Date: May 20, 2004

(54) Multi-indexed relationship media organization system

(76) Inventor: Dan Huang, Irvine, CA (US)

Correspondence Address: Clement Cheng, 17220 Newhope St. #127, Fountain Vallev, CA, 92708, US

(21) Appl. No.: 10/299,321

(22) Filed: Nov. 19, 2002

(51) Int. Cl. G06F 17/30

(52) U.S. Cl. 707/3

(57) ABSTRACT

A computer program for organizing and retrieving media files comprising: a dynamic folder structure generation means to acquire or import media files into the system, a media file related people management unit to organize people in a family tree, a media profiler, and a search subsystem to locate media files.

### DISCUSSION OF RELATED ART

Organizing family photographs can be a daunting task. Oftentimes, the sheer number of photographs makes the organization and retrieval process extremely difficult. Prior inventors have attempted to create an indexing system, however these systems are difficult to implement. Inventor Pflug of U.S. Pat. No. 6,273,472 discloses a photo album organizer system for organizing large amounts of photographs and for readily identifying storage volumes and their contents. Pflug discloses that multiple binders are used in a series to store photographs and each binder has photograph-receiving sheets for storing the photos to be viewed. Pflug discloses that each binder in the series has information pertaining to the yearly span, date, family surname, subject matter, or other information to identify the material in the particular binder and in the series of binders to index the information into a readily usable form. Pflug discloses that most people would get lost trying to keep track of so much information.

With the advent of digital cameras, people are taking more pictures and mixing still photographs with electronic multimedia such as camcorder video. Digital media files have becoming prevalent in our lives, as evidenced by the popularity of MP3 players, digital cameras, and digital camcorders. As one encounters an increasingly large number of digital files, it is desirable to provide a computer software application that can easily collect, manage, and search for these media files.

Various indexes related to technical information such as length or file size and identifiers such as keywords allow use of retrieval. This is well understood in the prior art. U.S. Pat. No. 5,267,351 Media Storage and Retrieval System describes a system for storing and indexing of media data based on user instructions; and uses source identifiers and range specification on the source of the data. U.S. Pat. No. 5,584,006 entitled Media Storage Retrieval System Including Determination of Media Data uses associated requests based on source identifiers and ranges within the media data. User instructions access relational information between media sources provided as well as a method for determining media based on source identifiers and range specification. U.S. Pat. No. 5,659,742 is a method for storing multi-media information in an information retrieval system. It describes a system for info storage and retrieval based upon a database query system. Text and images stored in system allow for searching. Searches use common text format to retrieve results. U.S. Pat. No. 5,761,655 entitled ‘Image File Storage and Retrieval System’ describes a system that creates, stores, and retrieves thumbnail images. Images can be indexed and searched using key words or by using “super-keywords” which combine keywords and other file and data characteristics. U.S. Pat. No. 5,895,464 entitled ‘Computer Program Product And A Method For Using Natural Language For The Description Search And Retrieval Of Multi-Media Objects’ describes a method of using natural language for querying in a database to retrieve multi-media objects and recognizes syntactic and semantic structure of the query. U.S. Pat. No. 6,232,539 Music Organization and Entertainment Center, describes a system that organizes and stores music and entertainment data files using pre-determined parameters such as title, artist, date, speed, dance characteristics, music style, etc. and also includes microprocessor and sound card functions. It offers random or pre-selected play back of songs. U.S. Pat. No. 6,415,301 Integrated Retrieval System, Integrated Retrieval Method and Media Recorded with Integrated Retrieval Program in Distributed File System, describes a retrieval storage system and method. It integrates using an agent in order to improve efficiency.

Many attempts at related technical information such as length or file size and identifiers such as the key words have proven to be of useful but limited value.

There are a number of products on the market today for digital photo management, such as iPhoto of Apple Computers, Inc. Most of these products use the concept of album to organize photos. Some of the products allow a user to classify photos into categories and have the ability to search for photos using category and keywords.

The common approach mentioned above lacks several features that could benefit the user to manage his/her digital media files. The prior software systems also do not integrate conveniences such as automatic folder generation and multiple means for searching for photographs in a relational manner.

### BRIEF DESCRIPTION OF THE DRAWINGS

FIG. 1 is a schematic flow diagram of media file importation process.

FIG. 2 is a schematic flow diagram of searching for media files related to a person.

FIG. 3 is a use case diagram describing the major scenarios of the system, i.e., importing, profiling, and searching for media files.

FIG. 4 illustrates a generalized architecture of the system.

FIG. 5 shows a file import dialog.

FIG. 6 shows attributes that the user can associate with the imported files.

FIG. 7 displays an editable dialog for modifying the attributes of one or a group of media files.

FIG. 8 presents how the user searches for media files.

FIG. 9 shows a typical family tree.

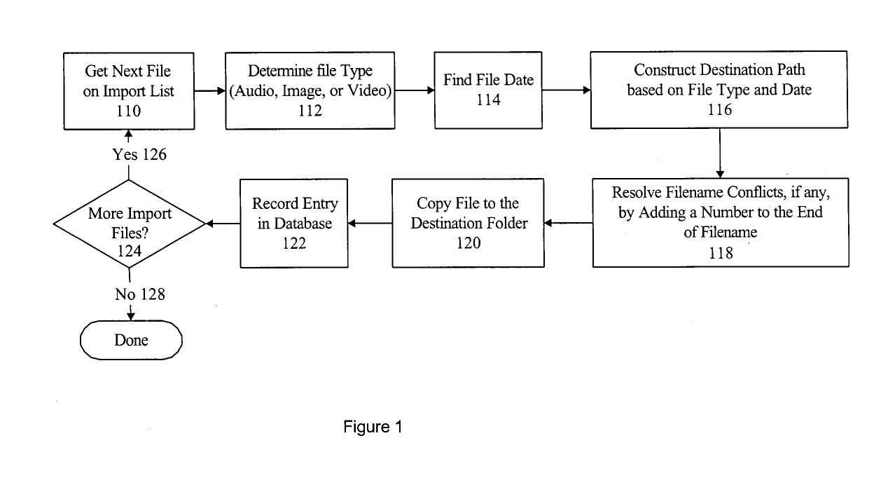

### SUMMARY OF THE INVENTION

The present invention is computer software system for storage, organizing, searching and retrieval for digital media files. The system provides an automatic generation of a folder structure based on the media file type (audio, image, or video) and a date pertaining to the file when a file is imported to the system. It also provides a means to relate a media file to people who are associated with the file, such as people in the picture and people taking the picture. The people management unit manages the relationships between persons and encompasses the tables and databases to accomplish this. The people management unit also presents a graphical representation of both familial and non-familial relationships. The system also provides a means to relate the people to the people associated with files. The present invention also has a means to organize people into a family tree structure, allowing familial relationship connected browsing of all the related people and a link to search for media files for the selected person.

### DESCRIPTION OF THE PREFERRED EMBODIMENT

The present invention, also called neoAlbum, relates to computer software applications that organizes and manages digital audio, image, and video files. A preferred embodiment of the present invention includes several subsystems: an automatic file folder generator when acquiring or importing media files into the system 312, a media file related people management unit to organize people in a family tree, a media profiler to profile media files 320, and a search subsystem to locate media files 330.

A user begins usage of the system by importing files. The method of importing files is commonly known in the industry and often includes downloading files from a flash memory card from a camcorder or digital camera.

The profile, such as the category, keywords, people related to the media file, is stored in the database along with the path of the file. The actual media file is unmodified.

After a user selects a group of files for import, the system automatically determine where and how the files are to be copied. Figure one shows the importation file process. Once a group of files are selected for import, the process begins by getting the next file on the import list 110. The system then determines the file type, that is, whether the file type is an audio file or a picture file or a video file 112. The system then finds a file date or assigns a file date 114. The system then constructs a destination path based on file type and the date assigned 116. The date assigned can be the file importation date or the file creation date. The file name conflict is resolved preferably by appending a number to the end of the file name 118. The file can then be copied into the destination folder 120. The record is then entered into the data base 122. The system then sees if more files need to be imported 124. The process repeats for the next file on the list until the end of the list. If the system is done with the batch, the file importation is finished 128.

Figure three shows detailed operation of the automatic importing and categorization of media files 312 that occurs immediately before copying files to the destination folder. The importation of media files was described above and can be simplified as the steps of designating source files 314, the automatically generating destination path depending file types and filed date or current date 316. The importation extracts file information such as title and artist information if it is available as in the case of MP3 files, and the saves them in a database 318. The files are then copied into destination folders 319.

The profiling is an assignment of values and descriptions to media. An example of the value profiled is a name of a person related to the media. To start profiling 320, one opens a media file or a group of media files in a list view 322. Then one opens the profile dialogue window 324. The people related to the media files can then be entered by the user 326 include categories and keywords associated with the media file. The media files preferably require one profiled person. The lone person may be the author or photographer in case of a media that does not show a subject person.

Media files can then be searched 330 by opening the family tree dialog window 332 and then selecting a person on the tree 334. The user may use a mouse to click a name or picture of a person on the tree to display related media files 336. A user may then additionally restrict the query by date range or by other Boolean limitation.

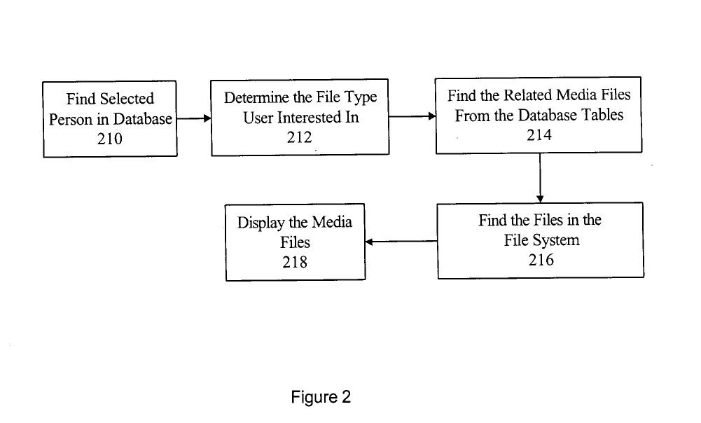

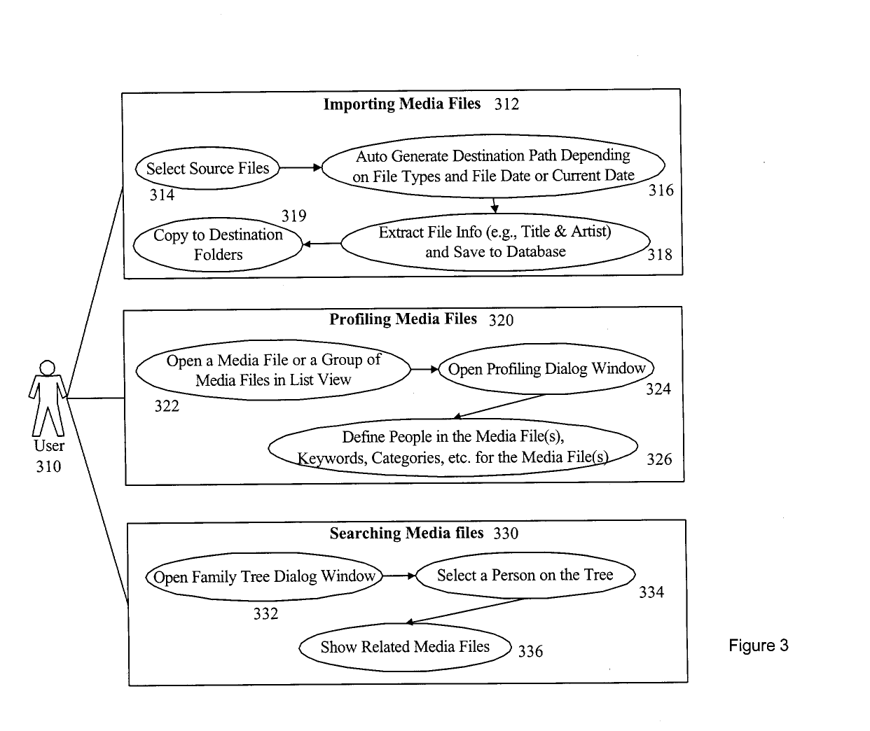

FIG. 2 shows an example of a routine for finding and displaying media related to a person. The process begins by a user deciding to find a person in the database 210. The person selection may be made indirectly by relative correlation to other relatives depending upon familial relationship or other personal relationship. The user then chooses a file type 212. The query system then uses the person and file type to find related media files from the database tables 214. The database tables then relates to files in the file system 216. The file system then displays the media files in a graphical format for the user to review 218. The person selection may be made by relative correlation to other relatives depending upon familial relationship or other personal relationship.

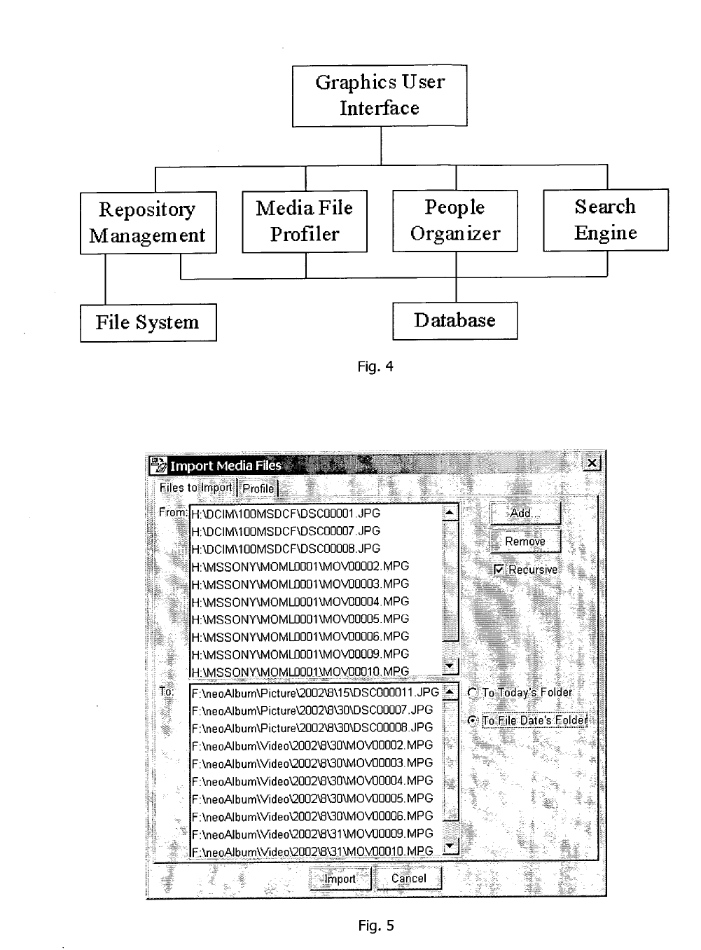

The architecture of the system is illustrated in FIG. 4. A Graphic User Interface (GUI) allows a user to control and perform different functions on the system. The repository management unit handles where imported files are placed and can generate appropriate folder structure based on the attributes of the files, such as file type (audio, image, or video) and file date. The media profiler unit manages and indexes the attributes of the media files, such as related people, category, keywords, and notes. The people organizer unit controls the list of people related to the media file and the relations, if any, among these people. A search unit gathers the criteria from the user input and generates the search results by querying the database. These units are linked to a database for storing the above-mentioned information.

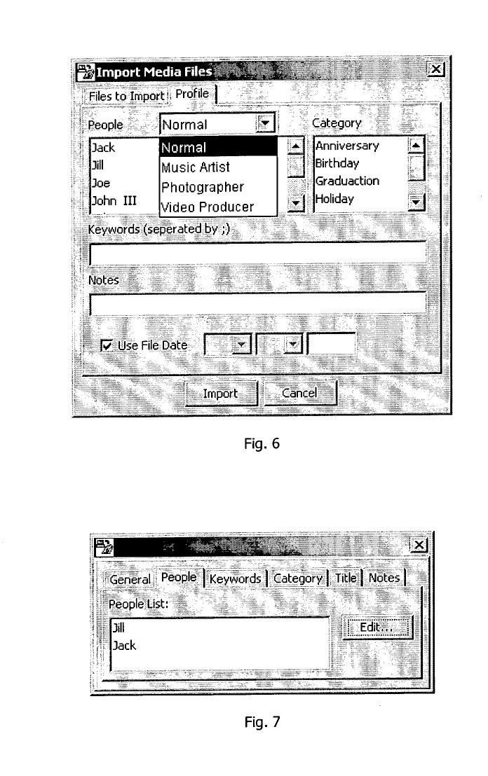

Typical usage begins with importing files from external devices, such as a digital camera. As shown in FIG. 5, when the user selects folders with “recursive” check box on, the system finds all the media files in the folders and subfolders and generates a list of file paths to copy the files to. The user has the options to use today's date or the file dates for the system to construct the paths. The “Profile” tab, as depicted in FIG. 6, shows several attributes that the user can associate all of the imported files to.

Profiling a media file can also be done at a later stage. The user can open one or a group of files, and classify them with a dialog shown in FIG. 7. A file can have people, category, keywords, title, and notes as attributes.

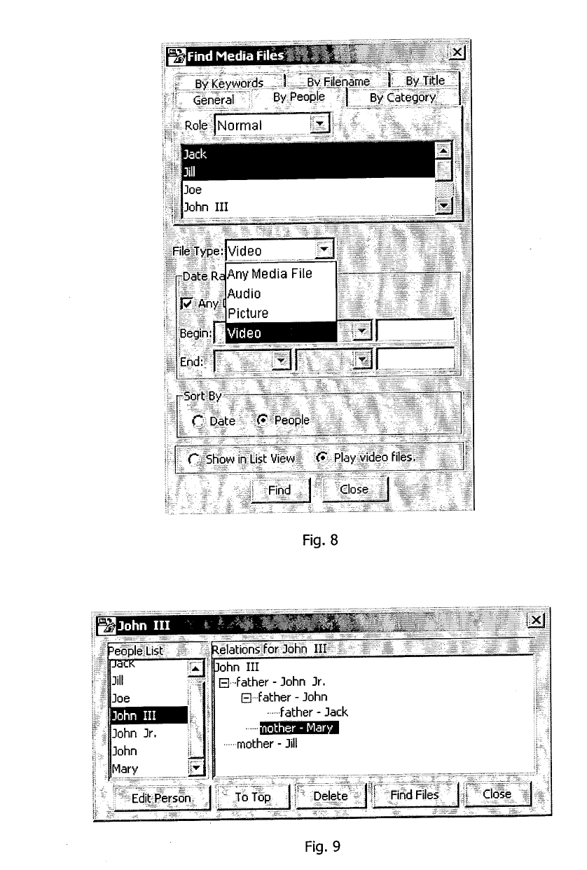

To search for media files, a dialog as shown in FIG. 8 is used. The user can search for media files (or of a particular type such as audio, picture, or video) by people, category, keywords, file name, and title. The system is also capable of displaying different groups of people, such as music artists for music files, photographers, camera men who take the video clips, and “normal people” who are in the pictures or video clips.

Since relating people to media files is an important part of the system, a meaningful organization of people is necessary. The system uses a family tree as shown in FIG. 9 to connect related people. The dialog also shows a link to search for media files for the selected people. The system may also allow a user to assign personal names to people in media photographs, and allow a user to assign the photographer name. After the personal name is entered into the computer, a photograph of a person may be tagged as having that person in the photograph digital file. Because it is difficult to remember the names of numerous third cousins and relatives, the computer also allows a user to define a relationship between various persons. This allows a user to search for the daughter of an uncle of a cousin rather than having to remember the actual person's name. The system indexes relationships of persons who are tagged to media files. The system additionally understands the familial or relationship and allows connected browsing. Date, time or place identifiers may restrict the browsing.

A relation definition table maintains definitions of relations between persons. A relation table maintains data on relations between persons. The data comprises a first person identification number, a second person identification number, and their relation.

The family tree can be adapted for places to make a place tree, and can be adapted for any other kind of relationship networked environment such as an organization chart of a corporate hierarchy. The family tree may also operated in conjunction with or ancillary to the corporate hierarchy chart or a location chart.

The Multiple Class GUI enabled indexing simplifies work in collecting and organizing digital media files. Once music files, photos or video clips are imported, a user can easily classify them according to date, category, keywords, people, and title. These criteria can be used later to search for media files. The key words can also be related by databases in the people management unit. Key words such as sports may encompass subsets of sports such as basketball or snow boarding. The relational database of the people management unit may further include a category such as sports that is yet another cross-index capability. The people management unit may also display a graphical index of sports such as individual sports or group sports teams. The people management unit may also use a ‘family tree’ type of graphical display for the officiating searches of media related to multiple classes. Because the present invention is embodied as a computer software system, various windows or displays of information are possible. Therefore a person may use simultaneously multiple graphical displays of keyword relationships, people relationships. This facilitates and officiates searches.

For example, a user may search for media related to a place. Places may also be related. For example London and Paris are both in Europe. For the geographically common locations the computer may keep a predefined list of relationships between places. If a user desires to find a picture of a second cousin's daughter who lives in Austin, Tex., but does not know how to spell

Austin, the user may limit the search to Texas. If the user does not know which of his second cousins lives in Texas, the user can limit the search to all second cousins. Assuming the user only has one second cousin with a daughter living in Texas, the user would be able to find the photograph. Therefore, while most picture indexing systems require an exact match, the current system indexes the indexes and so on and so forth so that exact matches are not required when searching.

The cross indexing system may also be multilingual. Assuming the relationships between the people in the photographs are French, French familial relationships in the Family tree may be used. In certain cultures such as Chinese, a different character is used for a mother's brother as opposed to a father's brother, even though in English the word is uncle. By allowing a user to switch language labels on the family tree, a multilingual user may refresh his recollection of familial relationships by changing the labels on the family tree display screen. The system keeps track of the names for the relationships that can be preprogrammed into a relationship index. The software system preferably has the following functions:

Search by People: Search photos or video clips of a person with options to specify file type and date range. Sort them according to date or people.

Search by Category: Similarly, media files can be searched and sorted by category.

Search by Keywords: You may specify one or more keywords to search for any media file.

Search by Title: For music files, a title search may be more convenient.

Search by File Name: Much faster than using the Windows search tool since file names are already in the database.

Edit Image Files

Text Annotation: Put text anywhere on the picture with ability to change font, font size, and color.

Brush: Draw with a brush for maximum flexibility.

Picture Frame: Put your favorate picture frame on a picture. You may also import picture frames into neoAlbum and use them on any picture.

Decoration: Decorate your picture with small images such as roses, stars, etc.

Crop: Crop a selected region in an image and save it to a different file.

Rotation: Rotate your picture for easy viewing.

Lightness, Contrast, and Saturation Adjustment: Adjust lightness, contrast, and saturation of your picture for better viewing.

Sharpness Adjustment: Sometimes, sharpening your image may improve picture quality.

Color Adjustment: Simple color adjustment based on the primary colors, red, green, blue, cyan, magenta, and yellow, is supported.

Image Size Adjustment: Change image size may be necessary such as to reduce the file size.

Play

Play Single File: You can play a single file if it is a audio or video file.

Play Mutliple Files: When you search for files, you have the option to play them continuously if they are audio or video files.

Invoke Default Player: If you prefer your default media player instead of the built-in player, you have the option to use it as your audio and video file player.

More

Email: Email one or more selected files using default email client.

Print: Print with preview and options to move and resize your images.

Export: You may export a group of files to a specified directory for special purposes, such as burning them on a CD.

Acquisition

Support for TWAIN acquisition: If your imaging devices is TWAIN compliant, you will be able to acquire images directly into neoAlbum.

Drag-and-drop from camera drive: If your digital camera shows up as a removable drive, you may drag and drop the folders on the drive to neoalbum. Auto processing of MP3 Files: When importing MP3 files, neoalbum will extract titles and artists from MP3 files if available and insert them into the database.

Organization

Auto sorting of imported files: Media files are put into different folders based on the file types, such as “My Pictures” and “My Videos” automatically when they are imported.

Auto generation of folder structure: A folder structure based on file types and file dates or todays date of the imported files can be auto generated when importing media files.

Family Tree: Build your family tree with neoAlbum. You can browse and search for any related person and find the media files of the person.

Call Out List

110 Get Next File on Import List

112 Determine file Type (Audio, Image or Video)

114 Find file Data

116 Construct Destination Path based on File Type and Data

118 Resolve Filename Conflicts, if any, by Adding a Number to the End of File Name

120 Copy File to the Destination Folder

122 Record Entry in Database

124 Query: More Import Files

126 Yes: Return to 110

128 NO

210 Find Selected Person in Database

212 Determine the File Type User Interested in

214 Find the Related Media Files From the Database Tables

216 Find the Files in the File System

218 Display the Media Fles

310 User

312 Importing Media Files

314 Select Source File

316 Auto Generate Destination Path Depending on File Types and File Data or Current Data

318 Extract File Iifo (eg. Title and Artist) and Save to Database

319 Copy to Destination Folders

320 Profiling Media Files

322 Open Media or a Group of Media Files in List View

324 Open Profiling Dialog Window

326 Define People in the Media File(s), Keywords, Categories, etc. for the Media File(s)

330 Searching Media Files

332 Open Family Tree Dialog Window

334 Select a Person on the Tree

336 Show Related Media Files

1. A computer program for organizing and retrieving media files comprising:
a. an automatic folder structure generation means in acquiring or importing media files into the system,
b. a media file related people management unit,
c. a media profiler, and
d. a search subsystem to locate media files.

2. The computer program for organizing and retrieving media files as described in claim 1, wherein the media profiler contains family relationships.

3. The computer program for organizing and retrieving media files as described in claim 1, wherein the media file related people management unit has database tables to remember people and their relations comprising: a person table in said database table maintains personal information and a unique identification number for each person in the table, a relation definition table that maintains definitions of relations between persons, a relation table maintains data on relations between persons, said data comprising a first person identification number, a second person identification number, and their relation, a graphical display means for displaying the family tree generated from the cross indexed information stored in the multiple tables of the media file related people management unit.

4. The computer program for organizing and retrieving media files as described in claim 1, wherein the media profiler contains a table of persons, a first table of relations between the persons, a second table of relations of said first table of relations, a means to display the first table in a graphical format.

5. The computer program for organizing and retrieving media files as described in claim 1, wherein automatic folder structure generation means is based on file types and file importing date.

6. The computer program for organizing and retrieving media files as described in claim 1, further comprising: a display of a graphical family tree representation of all people related to the media files wherein a search subsystem locates media files related to selected people, the graphical family tree representation being linked to execute search queries of persons graphically selected by a user.

7. A computer-implemented process for facilitating access to media files stored in a computer-readable database, comprising the steps of:
a. dynamically generating a folder structure upon acquiring or importing media files into the system,
b. automatically storing a user's media according to the folder structure by profiling media via a media profiler,
c. allowing a user to define relative personal relationships,
d. managing media files via a people management unit,
e. receiving a request with a search subsystem to locate media files, and
f. locating the media file corresponding to the request

8. The method of claim 7 further comprising the step of:
Implementing multilingual cross indexing system tags

9. The method of claim 7 wherein importing a plurality of digital media is done by an automatic folder structure generation means to acquire or import media files into the system.

10. A method of providing a comprehensive digital media collection system comprising the steps of:
a. Importing a plurality of digital media,
b. Storing the profile of said digital media in a database,
c. Allowing a user to define relative personal relationships,
d. Organizing the digital media by a media file related people management unit,
e. Accessing the digital media via a graphical family tree display.

11. The method of claim 10 further comprising the step of:
Implementing multilingual cross indexing system tags

12. The method of claim 10 wherein importing a plurality of digital media is done by an automatic folder structure generation means to acquire or import media files into the system.
